(19) United States
(12) Patent Application Publication
(10) Pub. No.: US 2015/0230626 A1
(43) Pub. Date: Aug. 20, 2015

(54) LEVELER MECHANISM FOR A MERCHANDISER

(71) Applicant: Hussmann Corporation, Bridgeton, MO (US)

(72) Inventors: Jafary H. Riaby, Anaheim Hills, CA (US); Michael Gillett, Chino, CA (US); Moisses Navarro, Chino, CA (US)

(21) Appl. No.: 14/622,245

(22) Filed: Feb. 13, 2015

Related U.S. Application Data
(60) Provisional application No. 61/940,234, filed on Feb. 14, 2014.

(51) Int. Cl. A47F 3/00; F16M 13/02; A47F 5/10; F16M 11/04

(52) U.S. Cl. CPC A47F 3/004; F16M 11/04; F16M 13/022; A47F 3/00; A47F 5/10

(57) ABSTRACT

A merchandiser including a case defining a product display area and having a base and a frame coupled to the base, and case structure coupled to the frame. The merchandiser also includes a leveler mechanism that is coupled to the case structure and that has a connector rod and a coupler attached adjacent an end of the connector rod. The leveler mechanism has a length defined by the connector rod and the coupler, and the connector rod is rotatable relative to the coupler to rotate to raise or lower the case structure based on the direction of rotation.

### CROSS-REFERENCE TO RELATED APPLICATIONS

This application claims priority to U.S. Provisional Application Number 61/940,234, filed Feb. 14, 2014, the entire contents of which are incorporated herein by reference.

### BACKGROUND

The present invention relates to an adjustment or leveler mechanism, and more specifically, a leveler mechanism to adjust a position of a canopy or shelf of a merchandiser.

Some existing merchandisers provide adjustment for leveling the top shelf or canopy of the merchandiser. However, conventional adjustment mechanisms require time-consuming disassembly and assembly of parts of the merchandiser to gain access to the mechanism and to make the adjustment. In addition, any product supported on the shelf must be removed prior to making the adjustment.

### SUMMARY

In one construction, the invention provides a merchandiser including a case defining a product display area and having a base and a frame coupled to the base, and case structure coupled to the frame. The merchandiser also includes a leveler mechanism that is coupled to the case structure and that has a connector rod and a coupler attached adjacent an end of the connector rod. The leveler mechanism has a length defined by the connector rod and the coupler, and the connector rod is rotatable relative to the coupler to rotate to raise or lower the case structure based on the direction of rotation.

In another construction, the merchandiser includes a leveler mechanism that is coupled to and extends between the frame and the case structure to support a distal end of the case structure. The leveler mechanism is rotatably adjustable about a longitudinal axis to adjust the case structure relative to horizontal.

In another construction, the invention provides a leveler mechanism that is configured to level case structure of a merchandiser relative to horizontal. The leveler mechanism includes a connector rod, a first coupler that is attached to a first end of the connector rod and that is configured to attach to the case structure, and a second coupler that is attached to a second end of the connector rod and that is configured to attach to a frame of the merchandiser. The connector rod is rotatable relative to the first and second couplers to increase or decrease a length of the leveler mechanism.

Other aspects of the invention will become apparent by consideration of the detailed description and accompanying drawings.

### BRIEF DESCRIPTION OF THE DRAWINGS

FIG. 1 is a perspective view of a refrigerated merchandiser including a leveler mechanism embodying the present invention.

FIG. 2 is a perspective view of a portion of the refrigerated merchandiser of FIG. 1.

FIG. 3 is an exploded view of a portion of the refrigerated merchandiser and the leveler mechanism.

FIG. 4 is a perspective view of an interior of the refrigerated merchandiser of FIG. 1 illustrating a cover over the leveler mechanism.

FIG. 5A is a top view of the leveler mechanism.

FIG. 5B is a front view of the leveler mechanism.

FIG. 5C is a perspective view of the leveler mechanism.

FIG. 5D is a side view of the leveler mechanism.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

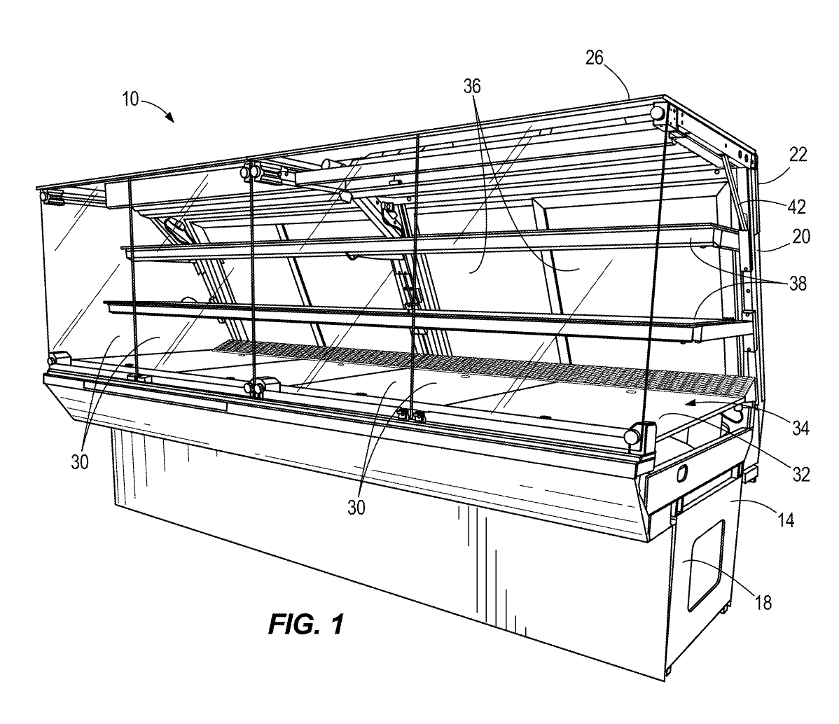

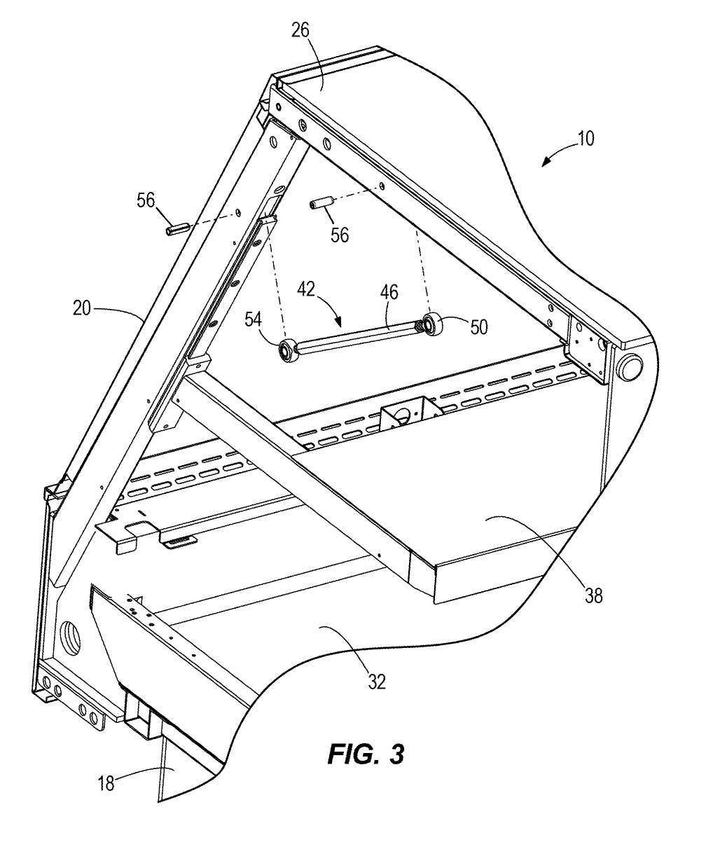

FIGS. 1-4 illustrate an exemplary merchandiser 10 that may be located in a supermarket or a convenience store (not shown) for presenting fresh food, beverages, and other product to consumers. As shown, the merchandiser 10 includes a case 14 that has a base 18 and a frame 20. The frame 20 includes a rear wall 22, a top wall or canopy 26, viewing panels 30, and a bottom wall 32 supported by the base 18. The illustrated viewing panels 30 are glass and are fixed in position, although the panels 30 can be replaced by movable structure (e.g., doors). As will be appreciated by one of ordinary skill in the art, the refrigerated merchandiser 10 also includes side walls that are not shown for clarity.

The area enclosed by the rear wall 22, the canopy 26, the panels 30, and the bottom wall 32 defines a product display area 34 that supports product in the case 14. As shown, access panels 36 are slidably coupled to the rear wall 22 to provide access to the product display area 34. The merchandiser 10 also has shelves 38 that extend outward from the frame 20 and that support product. The canopy 26 and the shelves 38 define case structure of the merchandiser 10. In some constructions, the case structure can include other structural components of the merchandiser 10. Depending on the desired temperature for the product display area 34, at least a portion of a refrigeration system can be supported by the merchandiser 10 (e.g., within the base 18) to condition (heat or cool) the product display area 34.

Referring to FIGS. 1-5D, the merchandiser 10 also includes an adjustment or leveler mechanism 42 that is coupled to and extends between the frame 20 and the case structure to permit adjustment of the case structure relative to horizontal. Although the leveler mechanism 42 is illustrated and described in detail as being coupled to the canopy 26 for adjustment of the canopy, it will be appreciated that the leveler mechanism 42 can be coupled to other case structure (e.g., a shelf 38) to provide adjustment of that case structure.

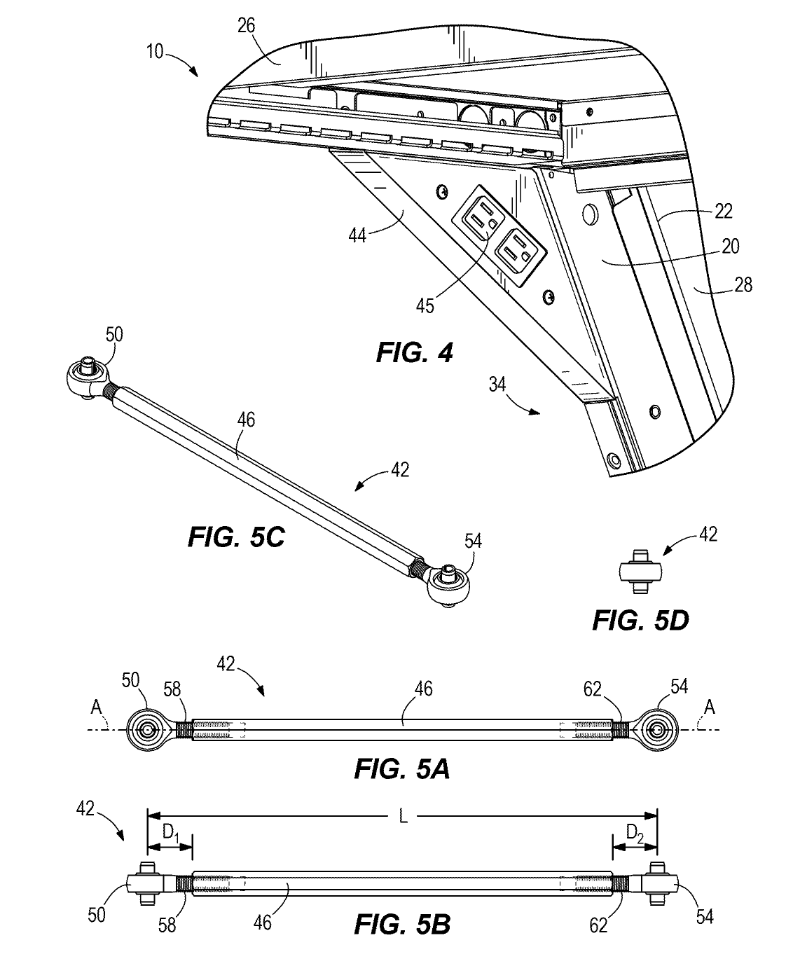

With reference to FIG. 4, a cover 44 can be coupled to the case 14 to enclose (or substantially enclose) the leveler mechanism 42. As illustrated, an electrical outlet receptacle 45 can be attached to the cover 44 and positioned in the space between the leveler mechanism 42 and the frame 20.

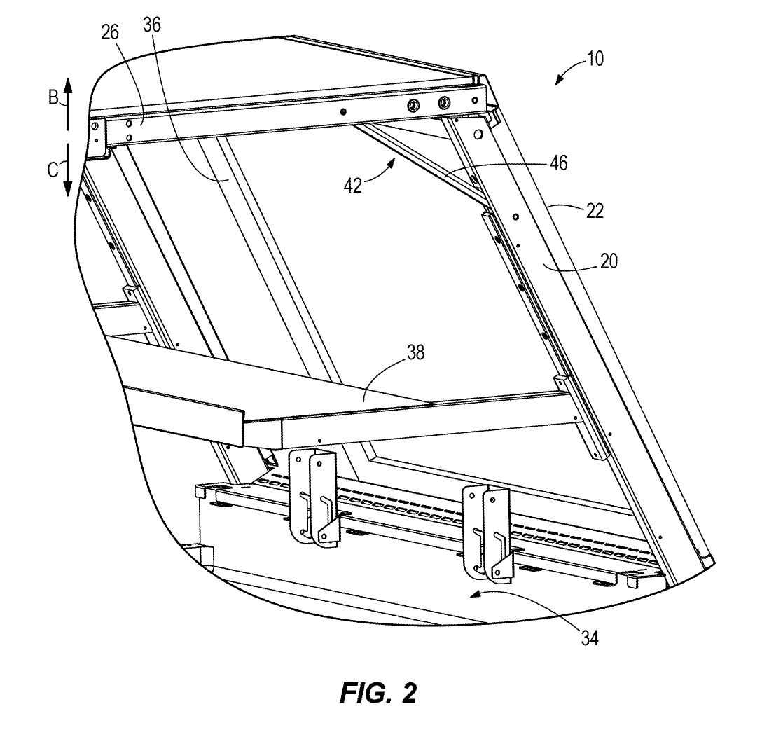

With reference to FIGS. 2, 3, and 5A-5D, the leveler mechanism 42 includes a shaft or connector rod 46 (e.g., a turnbuckle) that defines a longitudinal axis A. A first coupler 50 with left hand threads 58 is threadably coupled to one end of the connector rod 46, and a second coupler 54 with right hand threads 62 is threadably coupled to the other end of the connector rod 46. As illustrated, the first coupler 50 and the second coupler 54 are defined by swivel ball end joints (e.g., engaged by pins or bolts 56) that attach to the canopy 26 and a rear part of the frame 20, although other suitable types of couplers can be provided. It will be appreciated that the threads of the couplers 50, 54 can be reversed.

The connector rod 46 is rotatable relative to the first coupler 50 and the second coupler 54 about the longitudinal axis A. Rotation of the connector rod 46 in a first direction (e.g., counter-clockwise when viewed from adjacent the panels 30 or the front of the case 14) increases a length L of the leveler mechanism 42 by decreasing the depths of threaded engagement by the first coupler 50 and the second coupler 54 within the rod 46. The length L of the leveler 42 is measured from the attachment point of the first coupler 50 to the attachment point of the second coupler 54. That is, rotation of the connector rod 46 in the first direction will increase a distance D1 between the end of the rod 46 and the attachment point of the first coupler 50 (e.g., the center of the swivel ball in the illustrated example), and will increase a distance D2 between the end of the rod 46 and the attachment point of the second coupler 54 (e.g., the center of the swivel ball in the illustrated example).

Rotation of the connector rod 46 in a second direction opposite the first direction (e.g., clockwise when viewed from adjacent the panels 30) decreases the length L of the leveler mechanism 42 by increasing the depths of threaded engagement by the first coupler 50 and the second coupler 54 within the rod 46. That is, rotation of the connector rod 46 in the second direction will decrease a distance D1 between the end of the rod 46 and the center of the first coupler 50, and decrease a distance D2 between the end of the rod 46 and the center of the second coupler 54. For example, rotation of the connector rod 46 from a nominal or “zero” position (with the couplers 50, 54 threaded approximately halfway into the rod 46) can increase or decrease the length L between approximately 0.125 inches and 0.50. For example, the length L of the illustrated leveler 42 can increase or decrease approximately 0.250 inches from the nominal position. In some examples, the length L can be increased or decreased smaller or larger distances.

In operation, rotating the connector rod 46 to increase the length L of the leveler 42 in turn raises the canopy 26. Likewise, rotating the connector rod 46 in the opposite direction decreases the length of the leveler 42, which lowers the canopy 26. More specifically, the proximal end of the canopy 26 that connects to the rear wall 22 of the frame 20 remains stationary, and the leveler 42 is used to raise and lower the distal end of the canopy 26 in order to level it. Raising and lowering the distal end of the canopy 26 angularly adjusts the canopy 26 so that it can be leveled regardless of load deflections or the angle defined by the surface supporting the merchandiser 10.

Although the leveler mechanism 42 is illustrated and described in detail with regard to leveling the canopy 26, the leveler mechanism 42 can be attached between the frame 20 and one or more shelves 38 to level or adjust the height of the shelf 38 in the same manner as described above. The level mechanism 42 can be used to adjust and level case structure of the merchandiser 10. Also, while the leveler mechanism 42 is illustrated on only one side of the case 14, it should be understood that another leveler mechanism 42 is positioned on the opposite side to provide an equal amount of adjustability.

After the merchandiser 10 is assembled with the leveler mechanism 42 attached between the rear part of the frame 20 and the canopy 26 (and/or a shelf 38), the connector rod 46 is rotated clockwise or counter-clockwise (e.g., using an open wrench or a user's hands) to adjust the height or level the canopy 26. Rotating the connector rod 46 in the first direction increases the overall length L, which in turn raises the front of the canopy 26 a small amount relative to the support surface (in the direction indicated by arrow B in FIG. 2) because the rear end of the leveler mechanism 42 is attached to the rigid frame structure. Likewise, rotating the connector rod 46 in the second direction decreases the overall length L, which in turn lowers the front of the canopy 26 a small amount relative to the support surface (in the direction indicated by arrow C in FIG. 2). In addition, the leveler mechanism 42 can adjust the height of the canopy 26 and/or the shelves 38 when product is loaded on the surfaces defined by the canopy 26 and the shelves 38 without having to remove the product. In other words, the leveler mechanism 42 can level the canopy 26/shelves 38 regardless of whether product is on the support surfaces, and can further provide height adjustment of the support surfaces to take into account the weight of product in the case 14 when product is loaded or removed without disassembling the merchandiser 10.

Various features and advantages of the invention are set forth in the following claims.

1. A merchandiser comprising:
a case defining a product display area and including a base and a frame coupled to the base; and
case structure coupled to the frame; and
a leveler mechanism coupled to the case structure and including a connector rod and a coupler attached adjacent an end of the connector rod, the leveler mechanism having a length defined by the connector rod and the coupler,
wherein the connector rod is rotatable relative to the coupler to rotate to raise or lower the case structure based on the direction of rotation.

2. The merchandiser of claim 1, wherein rotation of the connector rod relative to the coupler adjusts the angle of the case structure relative to the frame.

3. The merchandiser of claim 1, wherein the case structure includes a canopy of the case or a shelf of the case.

4. The merchandiser of claim 1, wherein the coupler is defined by a turnbuckle.

5. The merchandiser of claim 1, wherein the coupler defines a first coupler positioned adjacent a first end of the connector rod and attached to one of the frame and the case structure, wherein the leveler mechanism further includes a second coupler positioned adjacent a second end of the connector rod and attached to the other of the frame and the case structure, and wherein the connector rod is rotatable relative to the first and second couplers to raise or lower the case structure.

6. The merchandiser of claim 5, wherein the first coupler and the second coupler are threadably attached to the connector rod.

7. The merchandiser of claim 1, wherein rotation of the connector rod in a first direction increases the length of the leveler mechanism to raise at least a portion of the case structure, and wherein rotation of the connector rod in a second direction decreases the length of the leveler mechanism to lower at least a portion of the case structure.

8. The merchandiser of claim 1, further including a cover at least partially enclosing the leveler mechanism and an electrical outlet receptacle coupled to the cover.

9. A merchandiser comprising:
a case defining a product display area and including a base and a frame coupled to the base;
case structure coupled to the frame; and
a leveler mechanism coupled to and extending between the frame and the case structure to support a distal end of the case structure, the leveler mechanism rotatably adjustable about a longitudinal axis to adjust the case structure relative to horizontal.

10. The merchandiser of claim 9, wherein the case structure includes a canopy of the case or a shelf of the case.

11. The merchandiser of claim 9, wherein the leveler mechanism is attached to the case structure at a location spaced inward from a cantilevered end of the case structure.

12. The merchandiser of claim 9, wherein the leveler mechanism includes a connector rod and a coupler threadably coupled to the connector rod.

13. The merchandiser of claim 12, wherein rotation of the connector rod relative to the coupler is configured to adjust the angle of the case structure relative to the frame.

14. The mechanism of claim 9, wherein the leveler mechanism includes a connector rod, a first coupler connected to a first end of the connector rod and coupled to the case structure, and a second coupler connected to a second end of the connector rod and coupled to the frame, wherein the connector rod is rotatable relative to the first and second couplers to raise or lower the case structure.

15. The merchandiser of claim 14, wherein rotation of the leveler mechanism in a first direction increases the length of the leveler mechanism to raise at least a portion of the case structure, and wherein rotation of the leveler mechanism in a second direction decreases the length of the leveler mechanism to lower at least a portion of the case structure.

16. The merchandiser of claim 9, wherein the leveler mechanism includes a swivel ball arrangement disposed on an end of the leveler mechanism, and wherein the leveler mechanism is coupled to the case structure via a pin received by the swivel ball arrangement.

17. A leveler mechanism configured to level case structure of a merchandiser relative to horizontal, the leveler mechanism comprising:
a connector rod;
a first coupler attached to a first end of the connector rod and configured to attach to the case structure; and
a second coupler attached to a second end of the connector rod and configured to attach to a frame of the merchandiser,
wherein the connector rod is rotatable relative to the first and second couplers to increase or decrease a length of the leveler mechanism.

18. The leveler mechanism of claim 17, wherein each of the first coupler and the second coupler is threadably coupled to the connector rod.

19. The leveler mechanism of claim 17, wherein each of the first coupler and the second coupler defines a swivel ball end joint.

20. The leveler mechanism of claim 17, wherein rotation of the leveler mechanism in a first direction increases the length of the leveler mechanism, and wherein rotation of the leveler mechanism in a second, opposite direction decreases the length of the leveler mechanism.
